(19) United States
(12) Patent Application Publication
(10) Pub. No.: US 2006/0211558 A1
(43) Pub. Date: Sep. 21, 2006

(54) Carton Feeder with Extended Carton Hold Down Member and Carton Guide

(76) Inventors: Michael F. Flagg, Newnan, GA (US); Rafe T. Patterson, Fortson, GA (US); Roman S. Hackworth, Lithia Springs, GA (US)

Correspondence Address: PARKS KNOWLTON LLC, 1117 PERIMETER CENTER WEST, SUITE E402, ATLANTA, GA, 30338, US

(21) Appl. No.: 11/277,119

(22) Filed: Mar. 21, 2006

Related U.S. Application Data
(60) Provisional application No. 60/664,325, filed on Mar. 21, 2005.

(51) Int. Cl. B31B 1/78

(52) U.S. Cl. 493/309

(57) ABSTRACT

A packaging machine includes a carton feeder with rotary feeders that select, transport, and partially erect collapsed sleeve-type cartons in preparation for loading articles into each partially erected carton before its ends are sealed. A guide causes the collapsed carton to conform to the orbital path of a transfer feeder so as to optimize its presentation for engagement by an erecting feeder. An extended carton hold down member stabilizes the collapsed carton so as to enable the transfer and the erecting feeders to briefly engage the collapsed carton simultaneously, thereby partially erecting the carton, while preventing fluttering and jamming caused by premature release of the carton. The guide also prevents the extended carton hold down member from interfering with the passage of the collapsed carton. The rear portion of the carton hold down member provides stabilizing pressure to prevent the carton from collapsing before it is loaded.

### CROSS-REFERENCE TO RELATED APPLICATIONS

This application claims priority to U.S. application Ser. No. 60/664,325, filed Mar. 21, 2005, the entirety of which is incorporated herein by reference.

### TECHNICAL FIELD

This invention relates generally to machines for erecting sleeve type cartons or other packages, and more particularly, to a carton guiding system that facilitates high speed feeding of such cartons from a carton hopper.

### BACKGROUND OF THE INVENTION

A continuous-motion automatic packaging machine rapidly applies secondary packaging to multiple individually packaged products, such as canned or bottled consumables, for greater ease of transportation, storage, sale, and consumer utilization. Many such packaging machines integrate several modular stations including carton erectors, case packers, carton sealing machines, palletisers, and interconnecting conveyor systems. The interconnecting conveyor systems convey the products through the other various modular stations and into each of a series of cartons. It is known to provide a packaging machine with a modular or integral carton feeder that is configured to erect sleeve type cartons. Sleeve type cartons are provided as carton blanks that are partially assembled and collapsed into tubular sleeves prior to being fed into the packaging machine. A typical carton feeder includes three rotary vacuum wheels, each including suction cups for engaging and disengaging cartons. The suction cups are selectively activated and deactivated by means of valves that are controlled by a computer processor.

Frequently, misfeeds occur as the cartons are transitioned from one vacuum wheel to another. In high speed packaging, when the leading edge of the carton is released by one vacuum wheel, the leading edge of the carton may flutter unpredictably. This flutter of the leading edge results in an unacceptably high probability that the leading edge of the carton will become crumpled or inverted at a region of engagement with another vacuum wheel assembly, which causes the packaging machine to become jammed or otherwise malfunction.

Clearing the jammed packaging machine necessitates time-consuming and, therefore, costly intervention by a human or mechanical operator. Alternatively, the packaging machine may continue to run despite the damaged, destroyed, or trapped carton. In this case, the packaging machine may expel bottles or other articles onto the conveyor where the carton should have been, which results in destruction of the articles, equipment malfunction, and again, costly intervention.

Clearly, it is desirable to have a continuous-motion packaging machine that prevents cartons from misfeeding.

### SUMMARY OF THE INVENTION

The various embodiments of the present invention overcome the shortcomings of the prior art by providing a rotary carton feeder with an improved carton hold down member, and a carton guide that prevent collapsed sleeve-type cartons from misfeeding. Advantageously, the carton hold down member and guide enable the machine to run at faster speeds with fewer misfeeds.

Generally, to teach the benefits of the various aspects of the invention, its various embodiments are described in the context of a continuous-motion packaging machine having a carton feeder including three rotary vacuum wheels, each with a number of suction cup stations, and each being rotatable about a fixed axis in an orbital path.

The first vacuum wheel, hereinafter referred to as the pickup feeder, continuously and sequentially engages and removes individual cartons from a carton hopper and transports each carton to the second vacuum wheel, hereinafter referred to as the transfer feeder. The transfer feeder transfers the carton from the pickup feeder to the third vacuum wheel, which is hereinafter referred to as the erecting feeder. The erecting feeder, in concert with the transfer feeder, opens the carton and places the carton on a carton conveyor, which transports the carton to a loading station.

As the cartons are transported by a vacuum wheel and relayed from one vacuum wheel to another, one or more means for guiding the cartons prevent misfeeds by holding each carton in the proper position to be engaged by the next vacuum wheel or to be conveyed away from the carton feeder. Means for guiding the cartons also function to reduce or eliminate unwanted flutter and deformation that can occur as each carton is relayed from one vacuum wheel to another.

In essence, the carton feeder is an apparatus for sequentially erecting a number of collapsed cartons. Certain elements of the carton feeder, i.e., the pickup feeder, the transfer feeder, and the erecting feeder cooperate to select, transport, relay, and at least partially erect each collapsed carton, which is then placed on the carton conveyor. These elements each include a feeder wheel to which several stations are radially attached. The suction stations comprise engaging means such as suction cups and associated components. The pickup feeder selects the endmost carton in the hopper by engaging a first face of the collapsed carton. As used herein, a face is a substantially flat surface that includes at least a portion of more than one panel that, when erected, comprises one or more carton walls. Alternatively, a face may be a single panel. Here, the examplary collapsed carton has two opposing faces with each face comprising two panels that are hingedly connected to one another. When erected, each panel becomes a carton wall. At least one of the panels on each face is defined in part by the leading edge of the carton and is hereinafter referred to as a leading panel.

To relay the still collapsed carton from the pickup feeder to the transfer feeder, the transfer feeder engages a second face of the collapsed carton as the pickup feeder disengages a first face. According to one aspect of the invention, a guide, which is disposed above the transfer feeder, prevents the leading edge of the carton from extending substantially outside of the radial path of the engaging means that are attached to the transfer feeder. The transfer feeder relays the collapsed carton to the erecting feeder, which engages the first face of the collapsed carton before the transfer feeder disengages the second face of the collapsed carton. Because both the transfer feeder and the erecting feeder maintain concurrent and at least partial engagement with the collapsed carton, the faces of the carton are pulled apart. The engaging means are preferably aligned and the rotation of the feeders is preferably synchronized to ensure that panels on the opposing faces of the collapsed carton are simultaneously engaged by the two feeders, thereby at least partially erecting the carton. Before the now partially erected carton can spring back to a collapsed state, the erecting feeder deposits the partially erected carton on the carton conveyor between two adjacent lugs. A carton hold down member applies downward pressure to the partially erected carton. The lugs and the carton hold down member prevent the carton from collapsing as it is conveyed toward the loading station.

In one embodiment, means for guiding the cartons includes the aforementioned guide, at least a portion of which has a degree of curvature that is similar to that of the transfer feeder. The guide is fixed above the transfer feeder and is spaced at a distance that is just sufficient to allow the unhindered, although guided, passage of a collapsed carton therebetween. A first end of the guide preferably extends at least toward the first region of engagement. That is, the area at which the carton pickup feeder releases at least a portion of each carton and at which the transfer feeder engages at least a portion of the carton. The first end may flare outward somewhat with respect to the circumference of the transfer feeder in order to easily capture and guide the leading edge of the carton. A second end of the guide extends at least toward the second region of engagement. That is, the area between the transfer feeder and the erecting feeder. The second end of the guide serves to prevent the leading edge of the carton from missing engagement by the erecting feeder, which could potentially cause the carton to become lodged between suction cups or stations of the erecting feeder. The guide ensures that the carton is held at the optimal inflection for engagement.

In another embodiment, means for guiding the cartons includes an improved carton hold down member. A rear end portion of the carton hold down member has the same, or a substantially similar, degree of curvature as that of the erecting feeder. The curved portion of the carton hold down member extends at least to the second region of engagement, which is defined as the area at which the transfer feeder releases at least a portion of each carton and at which the erecting feeder engages at least a portion of the carton. This rear end portion is disposed alongside each of the end plates comprising the erecting feeder wheel. The rear end portion comprises two blades, each disposed along side each of the end plates comprising each the erecting feeder. The carton hold down member reduces the flutter that normally occurs when the leading edge of the carton is released by the transfer feeder. The leading edge of each carton can be released by the transfer feeder much sooner than with prior art carton feeders.

Other embodiments include both the guide and the carton hold down member, which cooperate to allow faster and more reliable operation. In these embodiments, the carton hold down member preferably extends vertically higher than the closest end of the guide.

The foregoing has broadly outlined some of the aspects and features of the present invention, which should be construed to be merely illustrative of various potential applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings, in addition to the scope of the invention defined by the claims.

### BRIEF DESCRIPTION OF THE DRAWINGS

FIG. 1 is a perspective view of an exemplary packaging machine.

FIG. 2 is a perspective view of an exemplary carton feeder.

FIG. 3 is a side elevation of a portion of an exemplary carton feeder including embodiments of carton guide means according to the various aspects of the present invention.

FIG. 4 is a perspective view of the carton hold down member of FIG. 2.

FIG. 5 is a perspective view of improved guide of FIG. 2.

FIG. 6 is a perspective view showing an alternative embodiment of a carton feeder, having a single end plate.

### DETAILED DESCRIPTION

As required, detailed embodiments of the present invention are disclosed herein. It will be understood that the disclosed embodiments are merely examples to illustrate aspects of the invention that may be embodied in various and alternative forms. The figures are not necessarily to scale, and some features may be exaggerated or minimized to show details of particular components. In other instances, well-known materials or methods have not been described in detail to avoid obscuring the present invention. For example, components of a packaging machine or carton feeder that are not relevant to the implementation of the invention may be omitted, obscured, scaled up or down, or depicted functionally rather than realistically. Therefore, specific structural and functional details disclosed herein are not to be interpreted as limiting, but as a basis for the claims and for teaching one skilled in the art to variously employ the present invention.

Referring now to the drawings in which like numerals indicate like elements throughout the several views, the drawings illustrate certain of the various aspects of exemplary embodiments of means for guiding cartons in a carton feeder according to the teachings of the present invention. In the embodiments described herein, the term “carton” refers, for the non-limiting purpose of illustrating the various features of the invention, to a collapsible sleeve-type carton for enclosing, carrying, and dispensing articles such as beverage bottles.

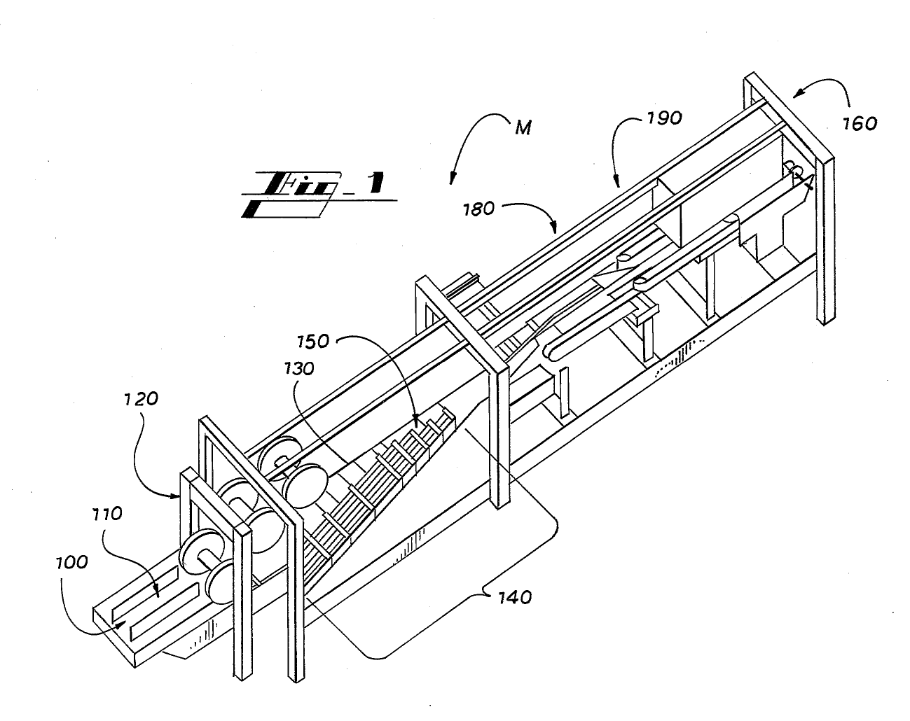

Referring first to FIG. 1, the various embodiments will be described in the context of a continuous-motion packaging machine M having a carton feeder 120. In the machine M, an infeed conveyor 100, in concert with a carton hopper 110, stages a stack of collapsed cartons for removal from the hopper 110 and introduction into the carton feeder 120. The hopper 110 is loaded with collapsed cartons that are stacked in the proper position and orientation, which in the exemplary embodiment is a substantially upright condition. The collapsed cartons are conveyed on the carton conveyor 100 toward the carton feeder 120, which sequentially withdraws the cartons from the carton hopper 110, substantially erects each carton, and subsequently deposits each carton onto a carton conveyor 130.

As cartons are continuously engaged and translated through the machine M, articles, such as bottles or beverage cans, are also transported through the machine M to be packaged in the cartons, and coincide with, the cartons. An article conveyor 140 and an article lane arrangement 150 form an article transport that conveys the articles into the cartons. Article-engaging wheels (not shown) complete the process of placement of the articles into cartons. Side-flap folding wheels (not shown) engage and inwardly fold the side flaps of cartons having side flaps. Glue is applied to the cartons at a gluing station 180. At a sealing station 190, end flaps of the cartons are pressed and held into contact with glue that has been previously applied. Packaged and sealed cartons are ejected from the machine at the ejection station 160.

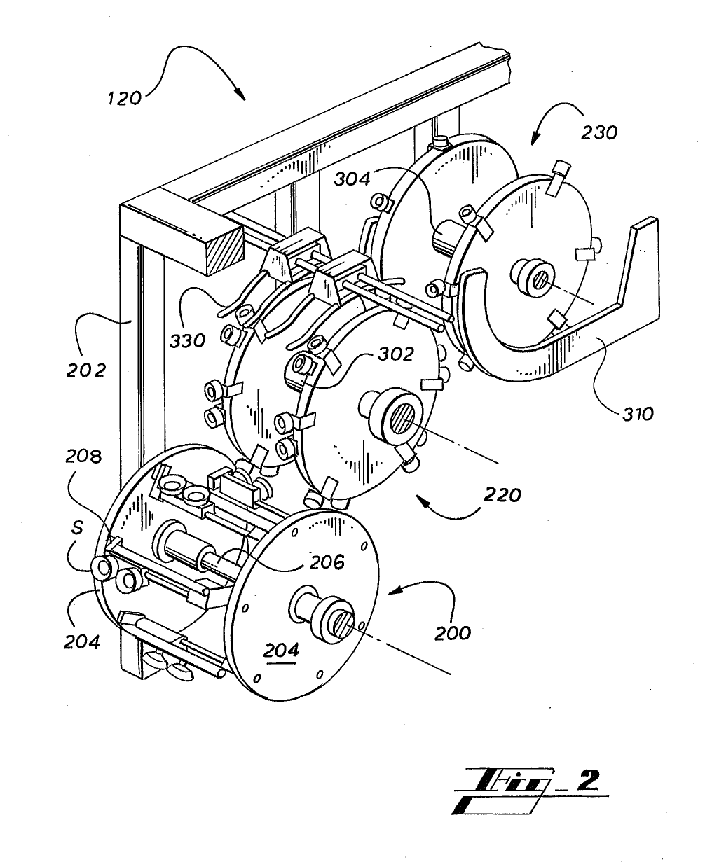

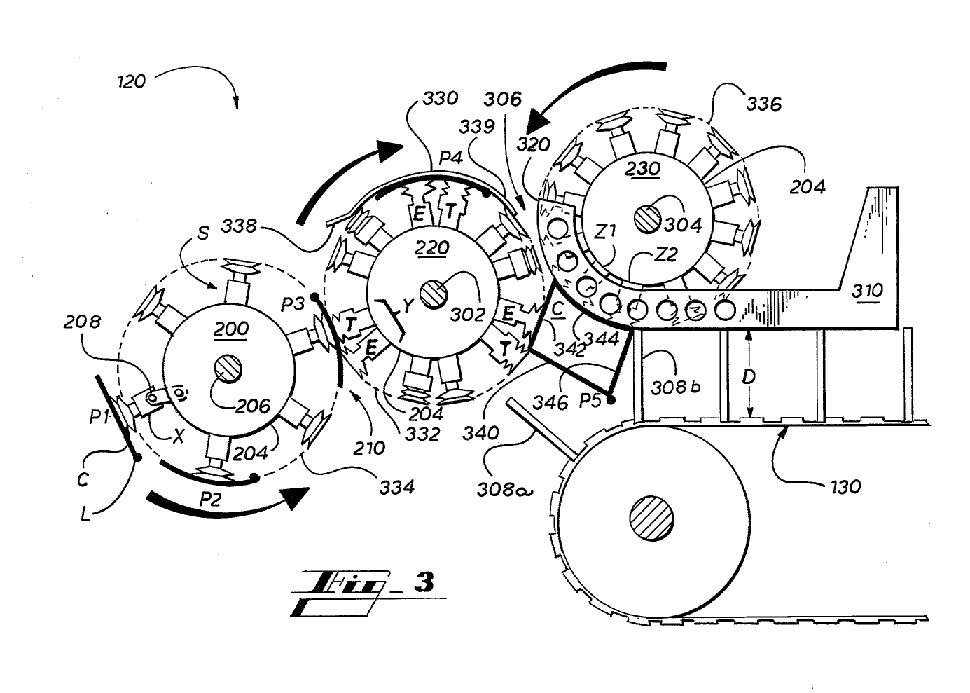

As can be seen in FIG. 2, the carton feeder 120 includes three vacuum wheels. Each vacuum wheel is supported by frame members 202. Each vacuum wheel includes at least two substantially circular rotatable end plates 204 that are fixedly secured to a drive shaft (best seen in FIG. 3) that extends at least partially through the center of each end plate 204. The drive shaft defines the axis of rotation of the respective vacuum wheel. In alternative embodiments, the shape of plates 204 may be elliptical, oval, or irregular, and cams may be utilized.

In operation, the first vacuum wheel, hereinafter referred to as the pickup feeder 200, functions to continuously select the endmost collapsed carton from the hopper 110. In the exemplary embodiment, the pickup feeder 200 rotates in a counterclockwise direction along with and about the axis of a drive shaft 206. For withdrawing the endmost carton (not shown) from the hopper 110, the pickup feeder 200 also includes a radially movable pickup arm 208 on which at least one suction station S is mounted.

Those skilled in the art will appreciate that each suction station S includes at least a suction cup and a manifold or other means for conveying negative pressure. There may be multiple types of suction stations S. For example, one type of suction station S is a primary or leading station T (best shown in FIG. 3) which has a more stable engaging surface that facilitates disengaging the carton. Another type of suction station S is a secondary or trailing station E (best shown in FIG. 3) which has greater suction and an extended suction cup with flexible lips that facilitate relaying between vacuums wheels. Either type of suction station S may utilize any type of engaging device such as a suction cup having single or multiple flexible bellows. The bellows design enables a suction cups to adhere to a slightly uneven, curved, or angled surface, such as the surface of the carton when it is engaged by a vacuum wheel.

The pickup arm 208 articulates away from the drive shaft 206 to place the suction stations S in proximity to engage the endmost carton (not shown) and then articulates toward the drive shaft 206 to convey the carton to a first region of engagement 210 (best shown in FIG. 3). The first region of engagement 210 is the area between the pickup feeder 200 and a second vacuum wheel, hereinafter referred to as the transfer feeder 220. The transfer feeder 220 and the third vacuum wheel, hereinafter referred to as the erecting feeder 230 (best shown in FIG. 3), complete the process of at least partially erecting the carton.

It should be noted that, as used with respect to the exemplary embodiment, the phrase “partially erected” refers to placing a tubular carton in a condition for loading from either or both ends. Specifically the carton is placed in a condition for loading by manipulating the hingedly connected walls of the carton until at least two walls are parallel to one another or are otherwise disposed to receive articles. For example, a rectangular carton will have a parallel top and bottom wall, as well as parallel side walls that are perpendicular to the top and bottom walls. A gable top carton can have parallel top and bottom walls and side having upper portions inclined toward one another, perhaps to conform to tapered articles such as beverage bottles.

A simplified and unobstructed view of a portion of the exemplary carton feeder 120 is shown in FIG. 3 to more clearly depict some of the pertinent elements three rotary vacuum wheels 200, 220, 230. Each of the rotary vacuum wheels 200, 220, 230 is independently rotatable about axes that are defined by respective drive shafts 206, 302, 304. Each vacuum wheel 200, 220, 230 has at least one, and preferably as many as eight, sets of one or more suction stations S for engaging, disengaging, manipulating, and depositing cartons in a substantially erect condition at the beginning of the carton conveyor 130. Although the precise number of suction stations S is not critical, and depends on the relative size of the cartons, the ratio of sets of suction stations S on each of the three wheels is preferably constant. In the exemplary embodiment, the pickup feeder 200 has six sets of two suction stations S and a set of suction stations S is disposed on each pickup arm 208. The transfer feeder 220 has six sets of four suction stations S, each set of suction stations S comprising two primary stations T and two secondary stations E that are disposed on opposing end plates 204 comprising the transfer feeder 220. The erecting feeder 230 has twelve sets of two suction stations S disposed on opposing end plates 204 comprising the erecting feeder 230. Thus, the ratio of sets of suction stations S disposed on the three exemplary feeders is 1:1:2.

The suction stations S comprising a set need not be aligned radially with respect to a respective drive shaft 206, 302, 304, and rather, may be radially staggered. In the exemplary embodiment, the positions of the individual suction stations S in each set that is attached to the transfer feeder 220 are staggered so that, for example, the primary and secondary suction stations T, E are arranged at an angular space about the drive shaft 302. The angular space between the primary and secondary suction stations T, E may be adjustable so as to accommodate different carton sizes. Furthermore, the primary and secondary suction stations T, E may be staggered in the horizontal plane as well. To be transferred from one vacuum wheel 200, 220, 230 to another or to the carton conveyor 130, each carton may be engaged by one or more sets of suction stations S on any one of the vacuum wheels 200, 220, 230.

FIG. 3 shows the path of a carton C at various positions P1, P2, P3, P4 and P5, as the carton C is transported through the carton feeder 120. At position P1, a first suction station set X pivots radially outward on pickup arm 208 to engage a first face of an endmost carton C. The pickup feeder 200 subsequently transports the carton C in a counter-clockwise direction through position P2 to the first region of engagement 210. In the first region of engagement 210, the carton C is at the position P3 and is relayed to the transfer feeder 220. The transfer feeder 220 includes a second suction station set Y, comprising primary and secondary suction stations T, E, that engages a second face of the still collapsed carton C as the first suction station set X on the pickup feeder 200 releases the carton C. Specifically, the primary suction stations T in the second suction station set Y on the transfer feeder 220 engages the second face of the carton C. The transfer feeder 220 transports the carton C in a clockwise direction to a position P4 where the carton C is adjacent to a guide 330 and the secondary suction stations E engage the second face of carton C. The carton C is then conveyed to a second region of engagement 306. At or before reaching the second region of engagement 306, the primary suction stations T of the second suction station set Y can release a portion of the second face of carton C, while the secondary suction stations E in second suction station set Y maintain suction on another portion of the second face of the carton C. Before the secondary suction stations E in the second suction station set Y disengage, third and fourth suction station sets Z1, Z2 on the erecting feeder 230 engage a portion of the first face of the carton C, that portion comprising uppermost wall 344 of the erected carton.

In this manner, the suction station sets Y, Z1, Z2 on the transfer and erecting feeders 220, 230 cooperate to respectively release and engage the carton C in such a manner as to begin erecting the carton C. It is at this point in the process that the timing of the relay is most critical. For example, the more square the erected carton C, the greater the tendency for the carton C to bow or flex rather than to open. The present invention advantageously prevents bowing with guide means comprising the guide 330, which ensures the carton C will be optimally positioned to be engaged by the suction station sets Z1, Z2, and comprising an improved carton hold down member 310, which stabilizes the leading edge L of the carton C as it is released by the primary suction stations T of suction station set Y. The carton hold down member 310 enables this release to occur sooner, because the carton hold down member 310 prevents the leading edge L from fluttering into the radial path 336 and also prevents a whiplash effect that can cause the carton C to remain collapsed, bowing rather than opening.

More specifically, at position P5 in the second region of engagement 306, the primary suction stations T of suction station set Y on the transfer feeder 220 releases the lowermost wall 340 of the carton C before or very soon after the third and fourth suction station sets Z1, Z2 on the erecting feeder 230 engage the carton C. Suction station sets Z1 and Z2 on the erecting feeder 230 are closer to one another than adjacent suction station sets Y on the transfer feeder 220, which enables both suction station sets Z1 and Z2 to be in contact with the uppermost wall 344 of the carton C at or near the same time. The secondary stations E of suction station set Y on the transfer feeder 220 continue to engage trailing wall 342 of the carton C for at least a short time after suction station sets Z1 and Z2 engage the carton C so that uppermost wall 344 and trailing wall 342 of the carton are pulled away from one another and thereby separated from one another as the carton C moves through the second region of engagement 306. The secondary suction stations E release the carton C around the time when a conveyor lug 308a is advanced into contact with the trailing wall 342 of the carton C, and/or the leading wall 346 is advanced into contact with conveyor lug 308b.

To substantially erect and maintain the desired shape of the erected carton C, the erecting feeder 230 transports the carton C to the carton conveyor 130 such that a lowermost wall 340 of the carton C is placed against the conveyor belt surface of carton conveyor 130, respective leading and trailing walls are placed adjacent to two consecutive carton conveyor lugs 308b and 308a, and the uppermost wall 344 of the carton C is held in place by the carton hold down member 310. More specifically, the carton hold down member 310 applies sufficient downward pressure on the uppermost wall of the carton to square the intersecting carton walls, thereby preventing the now partially erected carton from collapsing or from taking a partially-collapsed form. Thus, the desired shape of the now partially erected carton C is maintained as the carton conveyor 130 transports the carton C to an article loading station (not shown) to be loaded with articles exiting the article conveyor 140. For clarity, the carton hold down member 310 is shown as semitransparent although it is actually constructed of any suitably strong and rigid material such as a metal alloy.

If the primary suction stations T of the transfer feeder 220 would not disengage the carton C before or at the same time as the suction station sets Z1 and Z2 of the erecting feeder 230 engage the carton C, the carton C would undergo unnecessary tension in opposite directions, possibly deforming the carton. However, sufficiently early disengagement by the primary suction stations T could cause the leading edge of the carton C to flutter undesirably such that the leading edge L of the carton C becomes lodged between the suction stations S on the erecting feeder 230 and the carton hold down member 310, causing the packaging machine M to jam or otherwise malfunction. As an advantage, the upwardly extended rear end portion 320 of the exemplary carton hold down member 310 enables the primary suction stations T on the transfer feeder 220 to disengage the carton before the erecting feeder 230 engages the carton C by preventing the leading edge of the carton from fluttering undesirably such that the leading edge of the carton becomes lodged between suction stations S on the erecting feeder 230 and the carton hold down member 310. The upper edge 320 of the carton hold down member 310 extends upward beyond the second region of engagement 306.

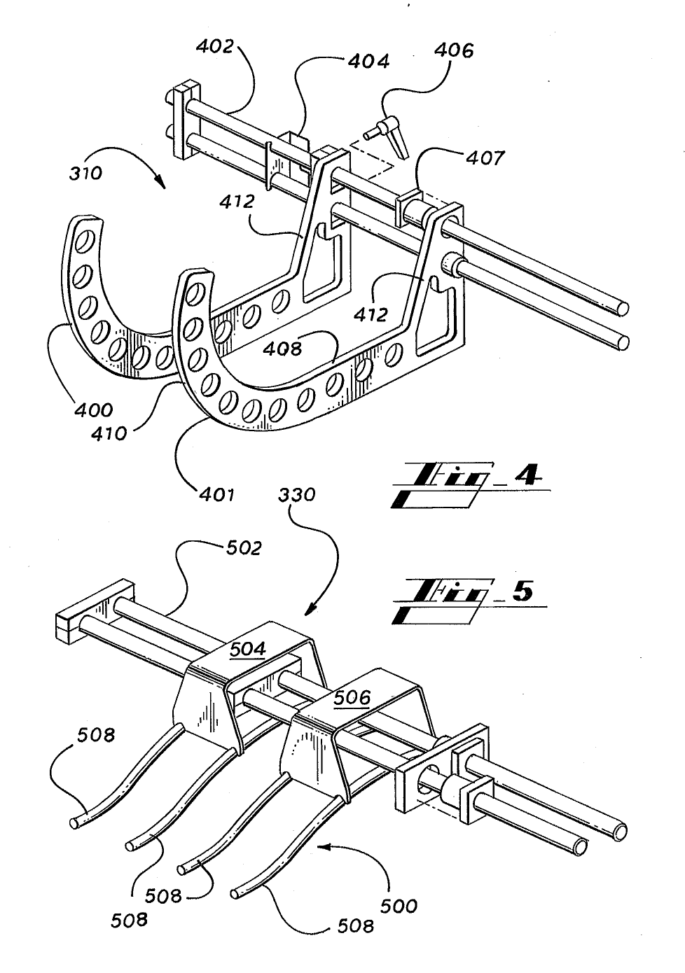

The structure of the carton hold down member 310 is now described in more detail with reference to FIG. 4. The carton hold down member 310 preferably includes one or more blades 400, 401 fixedly mounted to one or more horizontal supports 402 that are configured to prevent rotation or torquing of the blades 400, 401. The horizontal supports are fixedly mounted to frame members 202. The horizontal position of one or both of the blades 400, 401 may be adjustable, so as to accommodate different carton sizes or machine configurations. In the embodiment shown, blade 400 is fixed while blade 401 is made slidable by means of flange pillow block 407. To lock blade 401 in place, saddle bracket 404 may be interposed between the supports 402 and locked into place with adjustable lever 406.

As mentioned above, the carton hold down member 310 is preferably formed from a strong rigid material, such as a metal or metal alloy. The rear end portion 320 of the carton hold down member 310 curves upward, and has the same radius of curvature as the path 336 of the suction stations on the erecting feeder 230. More specifically, each blade 400, 401 of the carton hold down member 310 has an inside edge 408 and an outside edge 410. The radius of curvature of the curved portion of outside edge 410 preferably conforms to the radius of path 336. The radius of curvature of the curved portion of inside edge 408 is preferably substantially equal to or greater than the radius of the end plates 204 of erecting feeder 230.

The curved portion of each blade 400, 401 is adjacent to a substantially straight portion of the blade 400, 401. The outside edge 410 of the straight portion of the blade 400, 401 is disposed at a distance D above the carton conveyor 130, where the distance D is substantially equal to or slightly greater than the height of a partially erected carton C. The distance D is preferably the optimal height to enable the carton hold down member 310 to prevent the carton C from losing the shape that is desirable for loading and sealing the carton C. The blades 400, 401 and/or the entire carton hold down member 310 is preferably but not necessarily vertically adjustable to accommodate different carton sizes, so the distance D may be variable. Terminating the substantially straight portion of the carton hold down member 310, a bracket 412 may be disposed at an end of each blade 400, 401 to facilitate mounting on the horizontal supports 402.

Referring again to FIG. 3, although the carton hold down member 310 allows the primary suction stations T of transfer feeder 220 to disengage earlier, the primary suction stations T on the transfer feeder 220 continue to engage each carton C until the leading edge L of the carton C has cleared the upper edge of the rear end portion 320 of the carton hold down member 310. To that end, a guide 330 is disposed above the transfer feeder 220, conforming to the circular path 332 of the suction stations T, E on the transfer feeder 220, with sufficient clearance to allow passage of the carton C therebetween. The guide 330 extends below the upper edge of the rear end portion 320 of the carton hold down member 310, thereby holding down the leading edge L of the carton C so that the carton cannot become lodged above the carton hold down member 310.

Misfeeds also occur after the carton C leaves the first region of engagement 210. The leading edge L of the carton C may not completely conform to the curvature of the transfer feeder 220, because the rigidity of the carton material may cause the leading edge L to tend to bow away from transfer feeder 220. This tendency can cause the leading edge L of the carton C to be bent backward or otherwise deformed. To counter this tendency, the carton guide 330 is disposed above the transfer feeder 220 in close proximity so as to guide the leading edge L of the carton C over the top of the transfer feeder 220 and to the second region of engagement 306. An end 338 of the guide 330 is preferably flared away from path 332 to maximize the likelihood that the leading edge L of the carton C will be captured by the guide 330. The opposite end 339 of the guide 330 extends toward and preferably beyond the horizontal plane defined by the rear end portion 320 of the carton hold down member 310, and in certain embodiments, also extends well into the second region of engagement 306.

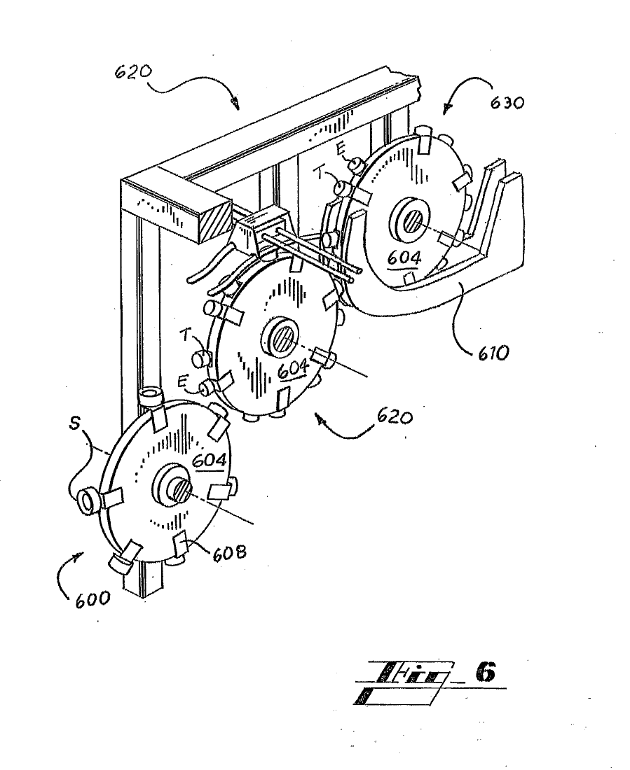

The structure of the guide 330 is now described in more detail with reference to FIG. 5. The guide 330 includes one or more curved members such as guide prongs 500. Prongs 500 can be utilized instead of a single unitary curved element to achieve the advantages of the invention while minimizing material consumption and weight of the guide 330. Use of two or more prongs 500 also provides adjustability, because each guide prong 500 or set of two or more guide prongs 500 can be separately and adjustably mounted to horizontal supports 502. In the embodiment shown, two guide prongs 500 are fixedly mounted such as by welding to a fixed guide bracket 504, which in turn, is fixedly mounted to horizontal supports 502. The horizontal supports are fixedly mounted to frame members 202. Another set of two guide prongs 500 is fixedly mounted to sliding guide bracket 506, which is adjustably mounted to horizontal supports 502. As mentioned above, one end 508 of each guide prong 500 flares, while the remainder of the guide 330 is curved to conform to the path 332 of the suction stations T, E on transfer feeder 220.

In an alternative embodiment shown in FIG. 6, vacuum wheels or feeders 600, 620, 630 include a single end plate 604 that is fixedly secured to a drive shaft that extends at least partially through the center of the end plate 604. The drive shaft defines the axis of rotation of the respective vacuum wheel. In operation, the pickup feeder 600 functions to continuously select the endmost collapsed carton from the hopper. The pickup feeder 600, rotates in a counterclockwise direction along with and about the axis of a drive shaft. In the exemplary embodiment, the pickup feeder 600 has six suction stations S fixedly attached to the end plate 604 by a bracket 608. The transfer feeder 620 has six sets of two suction stations S, each set of suction stations S comprising a primary station T and a secondary station E that are disposed on an end plate 604. The erecting feeder 630 has six sets of two suction stations S, each set of suction stations S comprising a primary station T and a secondary station E that are disposed on an end plate 604. The erecting feeder 630 is disposed between opposing carton hold down members 610.

The present invention has been illustrated in relation to a particular embodiment which is intended in all respects to be illustrative rather than restrictive. Those skilled in the art will recognize that the present invention is capable of many modifications and variations without departing from the scope of the invention. In fact, in the example described above, the carton C is oriented for loading of cans or other articles that are loaded vertically and then carried horizontally, so the uppermost wall 344 may actually be a side wall of the erected and loaded carton C. However, other article configurations require loading the carton in the same orientation as the articles will be carried, particularly when the articles are bottles or the like. In those configurations, the uppermost wall may be the top wall of the carton C.

Furthermore, the teachings and principles of the invention are applicable in any number of variations of carton feeders having orbital paths. For example, FIG. 6 depicts an embodiment of a carton feeder 620 with feeder wheels that include only one end plate 604, where the suction stations S are mounted about the periphery of the end plate 604 without the need of a pickup arm. Rather, the suction station S is fixedly or articulatably mounted directly to the end plate 604 in carton feeder 620.

Any reference to hinged connection should not be construed as necessarily referring to a junction including a single hinge only; indeed, it is envisaged that hinged connection can be formed from one or more potentially disparate means for hingedly connecting materials. As used herein, directional references such as “top”, “base”, “bottom”, “end”, “side”, “inner”, “outer”, “upper”, “middle”, “lower”, “front”, and “rear” do not limit the respective walls of the carton to such orientation, but merely serve to distinguish these walls from one another.

Those skilled in the art will also appreciate that the packaging machine described represents only one example of the various packaging machine types and configurations that will be suitable for implementation of the various embodiments of the invention. In addition, any suitable picking and placing device may be used in addition to or instead of suction stations, including magnets, non-permanent adhesives, or hook and loop fasteners such as VELCRO®, which is a trademark registered to Velcro Industries B.V. The exemplary suction stations may utilize any negative pressure generating devices and principles, including without limitation, Venturi or Bernoulli suction devices, which may but do not necessarily contact the surface of the article to be engaged and disengaged. Accordingly, the scope of the present invention is described by the claims appended hereto and supported by the foregoing.

What is claimed is:

1. An apparatus for erecting a collapsed carton in a packaging machine having a carton conveyor, the collapsed carton having a first face and an opposed second face, the apparatus comprising:
a transfer feeder comprising a plurality of engaging means, the transfer feeder being for engaging the second face of the collapsed carton in a first region of engagement and for transporting the collapsed carton to a second region of engagement;
an erecting feeder, comprising:
means for engaging the first face of the collapsed carton in the second region of engagement before the transfer feeder disengages the second face of the collapsed carton, thereby at least partially erecting the carton; and
means for placing the partially erected carton on the carton conveyor; and
a carton hold down member for applying pressure normal to the surface of the carton conveyor to the partially erected carton to prevent the partially erected carton from collapsing, the carton hold down member comprising a rear end portion that extends into the second region of engagement.

2. The apparatus of claim 1, further comprising:
a hopper for holding a stack of collapsed cartons; and
a pickup feeder comprising a plurality of engaging means, the pickup feeder being for selecting the collapsed carton from the stack by engaging the first face of the collapsed carton and for transporting the carton to a first region of engagement;
wherein the transfer feeder engages the second face at substantially the same time as the pickup feeder disengages the first face.

3. The apparatus of claim 1, further comprising a plurality of lugs mounted perpendicular to the carton conveyor, the lugs being for applying support to the partially erected carton to prevent the partially erected carton from collapsing.

4. The apparatus of claim 1, further comprising a guide disposed above the transfer feeder, the guide being for controlling a leading edge of the collapsed carton until the erecting feeder engages the first face in the second region of engagement.

5. The apparatus of claim 4, wherein the guide comprises at least one curved member that causes the leading edge to conform to the curvature of the transfer feeder.

6. The apparatus of claim 1, wherein the carton hold down member further comprises a front end portion that extends through the second region of engagement, the front end portion being for limiting the degree to which a leading edge of the collapsed carton can deflect toward the erecting feeder.

7. A packaging machine for packaging articles into cartons, comprising:
a hopper for queuing a stack of collapsed cartons;
a carton conveyor for conveying a carton through the packaging machine; and
a carton feeding and erecting mechanism for supplying the cartons to the carton conveyor, comprising:
a first feeder adjacent to the hopper, comprising:
at least one end plate that is rotatable about an axis of rotation, thereby to define a first orbital path; and
at least one first engaging means extending radially outward from the axis of rotation and beyond the periphery of the end plate during at least a portion of the orbital path, the at least one first engaging means being for removing the endmost collapsed carton from the hopper by engaging a first face of the endmost collapsed carton as the endmost collapsed carton is transported by rotation of the end plate to a first region of engagement;
a second feeder adjacent to the first feeder, the second feeder comprising:
at least one second end plate that is rotatable about a second axis of rotation, thereby to define a second orbital path;
at least one second engaging means being for engaging a second face of the endmost collapsed carton in the second region of engagement as the at least one first engaging means releases the endmost collapsed carton; and
a guide disposed generally above the second feeder, the guide having a curved member, the curvature of which approximates the curvature of the second orbital path, the guide being in proximity to the second end plate so as to cause the endmost collapsed carton to conform to the second orbital path.

8. The packaging machine of claim 7, wherein the first and second orbital paths are substantially circular and tangential.

9. The packaging machine of claim 7, further comprising:
a third feeder adjacent to said second feeder and disposed generally above the carton conveyor, the third feeder comprising:
at least one third end plate that is rotatable about a third axis of rotation, thereby to define a third orbital path;
at least one third engaging means being for engaging a first face of the endmost collapsed carton in the second region of engagement before the at least one second engaging means releases second face of the endmost collapsed carton, thereby at least partially erecting the carton.

10. The packaging machine of claim 9, further comprising a carton hold down member disposed generally above the carton conveyor and adjacent to the third end plate, the carton hold down member having a rear end portion that extends into the second region of engagement, the rear end portion being for applying pressure normal to the surface of the carton conveyor to at least a portion of the first face of the carton to prevent the partially erected carton from collapsing.

11. The packaging machine of claim 10, the carton hold down member further comprising a front end portion having a radius of curvature that approximates and is aligned with a portion of the third orbital path.
